(19) United States
(12) Patent Application Publication
(10) Pub. No.: US 2026/0180909 A1
(43) Pub. Date: Jun. 25, 2026

(54) Stream Replacement Algorithm

(71) Applicant: SambaNova Systems, Inc., Palo Alto, CA (US)

(72) Inventors: John Philipp BAXLEY, Arlington, VA (US); Manish K. SHAH, Austin, TX (US); Pranjali Kartik Bakeri, San Jose, CA (US); Sripathi Muralitharan, Mountain View, CA (US)

(73) Assignee: SambaNova Systems, Inc., Palo Alto, CA (US)

(21) Appl. No.: 18/991,848

(22) Filed: Dec. 23, 2024

(51) Int. Cl. H04L 47/24; H04L 47/215

(52) U.S. Cl. CPC H04L 47/24; H04L 47/215

(57) ABSTRACT

A system and method are provided that prioritizes activation of network streams providing communications across chips. The method associates a counter with each of the streams. The counter associated with each stream is reset to zero when the stream transitions from an active to an inactive state, and then the counter is incremented when any other of the streams transition from an active to an inactive state such that the inactive streams with the highest count value have been inactive the longest. The inactive streams are assigned to a vector bit indicative of the total streams available within a plurality of buckets based on the counter values assigned to the buckets. Inactive streams are then selected for activation from the buckets, with buckets having streams with higher counter values having higher priority for activation.

### TECHNICAL FIELD

The present subject matter relates to communication between integrated circuit reconfigurable processor chips. More specifically the present disclosure relates

communication between chips that are interconnected in a network environment.

### BACKGROUND

Reconfigurable processors, including field programmable gate arrays (FPGAs), can be configured to implement a variety of functions more efficiently or faster than might be achieved using a general-purpose processor executing a computer program. So called Coarse-Grained Reconfigurable Processors (CGRPs) are being developed in which the configurable unit is more complex than used in typical, more fine-grained FPGAs, and may enable faster or more efficient execution of various classes of functions. For example, CGRPs have been proposed that enable implementation of energy-efficient accelerators for machine learning and artificial intelligence workloads.

### SUMMARY

Embodiments described herein include a system and method that prioritizes activation of network streams that provide communications across an array of CGRP chips. The method associates a counter with each of the network streams that are available for communication between the CGRP chips. The counter associated with each stream is reset to zero when the stream transitions from an active to an inactive state, and then the counter is incremented when any other of the streams transition from an active to an inactive state such that the inactive streams with the highest count value have been inactive the longest. The inactive streams are assigned to a vector bit indicative of the total streams available within a plurality of buckets based on the counter values assigned to the buckets. Inactive streams are then selected for activation from the buckets, with buckets having streams with higher counter values having higher priority for activation.

Certain embodiments of the method further provide for numbering of the buckets and use of vector bits set within the buckets to prioritize streams for activation. The buckets are numbered with the lowest identification number having streams assigned that have the highest counter values. With such numbering, buckets with the lowest identification number having streams with highest counter values have a stream selected for activation first. The method selects a stream for activation by evaluating the buckets beginning with the lowest identification number and proceeding to a higher identification number until a bucket is identified with a vector bit set indicating at least one stream within the bucket is available for activation. A stream within the bucket identified will then be moved to an active state.

In certain embodiments of the method, network streams can be mapped into multiple ones of the buckets with the counter values allowed for the buckets overlapping. An inactive network stream under such conditions will be mapped into multiple ones of the buckets when the counter value for the given stream falls within a range of count values assigned to multiple buckets.

In certain embodiments of the method, when there are multiple inactive streams within a bucket a given inactive network stream within a bucket can be assigned for activation either randomly or based which stream within the bucket available for activation has the higher count value. Once a bucket is selected with a vector bit set indicative of an inactive network stream available for activation, to save time when multiple vector bits are set a first one of the vector bits identified at random is selected for activation even if its count value is not the highest with the bucket. In another embodiment, when multiple network streams are available within a bucket for activation a further evaluation is made to identify a network stream with the highest count value within the bucket to assign for activation.

Certain embodiments of the method described herein provide the following three guarantees: 1. Any active network stream is not replaced; 2. The network stream that has been inactive for the longest duration, or as close as possible to the longest duration, is the stream chosen to be replaced by the new unmapped stream; and 3. When there are no inactive network streams and a logic stream becomes available for transmission, the transmitter for the logic stream becomes inactive until one of the network streams becomes inactive.

Embodiments of a system of the present invention include a plurality of chips with a network interconnecting the chips. Control logic then provides dataflow traffic control over the network using hardware logic elements rather than processors to control the activation of network steams that can be transmitted over the network according to methods of the present invention. In certain embodiments, the network is an Ethernet network using shim connections between the chips. In certain embodiments the chips can include reconfigurable processors. In some embodiments the reconfigurable processors can be reconfigurable dataflow units (RDUs) that provide a tiled architecture that provides for both hardware and software stacks for AI.

### BRIEF DESCRIPTION OF THE DRAWINGS

The technology disclosed is described with reference to the drawings, in which:

FIG. 1 shows a simplified block diagram illustrating an example reconfigurable processor chip architecture system for extending dataflow through a network between the processor chips used with embodiments of the present disclosure.

FIG. 2 shows further details of the interconnection network of the architecture of FIG. 1, according to embodiments of the present disclosure.

FIG. 3 is a block diagram illustrating features of an embodiment for the configuration of components in the control logic in the interconnection network of FIG. 1 to control stream replacement that illustrates the concept of buckets.

FIG. 4 is a flowchart showing method steps for a stream replacement algorithm according to embodiments of the present disclosure.

FIG. 5 is a flowchart showing further detailed steps for the step of selecting streams for replacing streams going inactive from FIG. 4.

FIG. 6 is a flowchart showing broadly method steps for a stream replacement algorithm from a time period of when a logic stream becomes available for transmission.

### DETAILED DESCRIPTION

Embodiments described herein provide a stream replacement algorithm in a reconfigurable processor architecture with the processor chips interconnected by a network over which the streams are transmitted. The stream replacement algorithm is provided to overcome the problem of inefficient and slow replacement of streams when the maximum number of streams are active and one of the streams transitions from active to inactive and is available for replacement. Embodiments described provide a solution to the problem with a counter assigned to each stream with the count value indicative of the stream that has been inactive the longest. Embodiments assign buckets within which streams that have counters within defined ranges are placed. Streams which have been inactive the longest are then identified by their count values to be activated first from within a bucket. The use of counters and buckets in this way provides an advantage of efficient and rapid identification of a stream that has been inactive the longest to make available for activation.

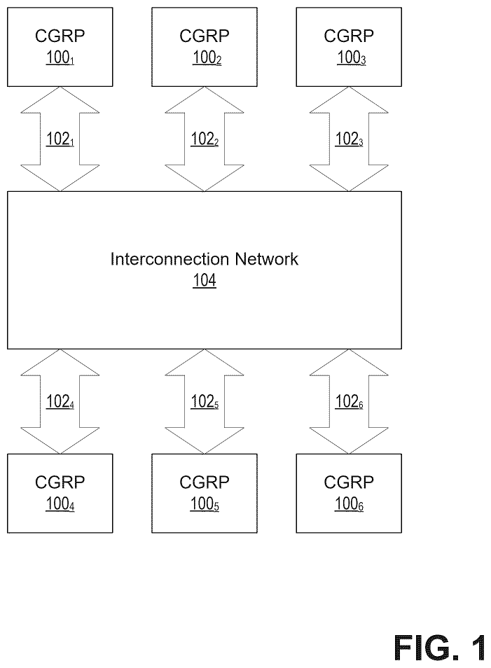

FIG. 1 shows a simplified block diagram illustrating an example reconfigurable processor chip architecture system for extending dataflow through a network between the processor chips as used with embodiments of the present disclosure. FIG. 1 includes Coarse-Grained Reconfigurable Processors (CGRPs) 100₁-100₆ provided on chips that have connections 102₁-102₆ to an interconnection network 104. The interconnection network 104 can include control logic hardware, and embodiments described herein are intended to use hardware control logic elements rather than a separate control processor with memory storing code to direct network streams between chips through the interconnection network 104.

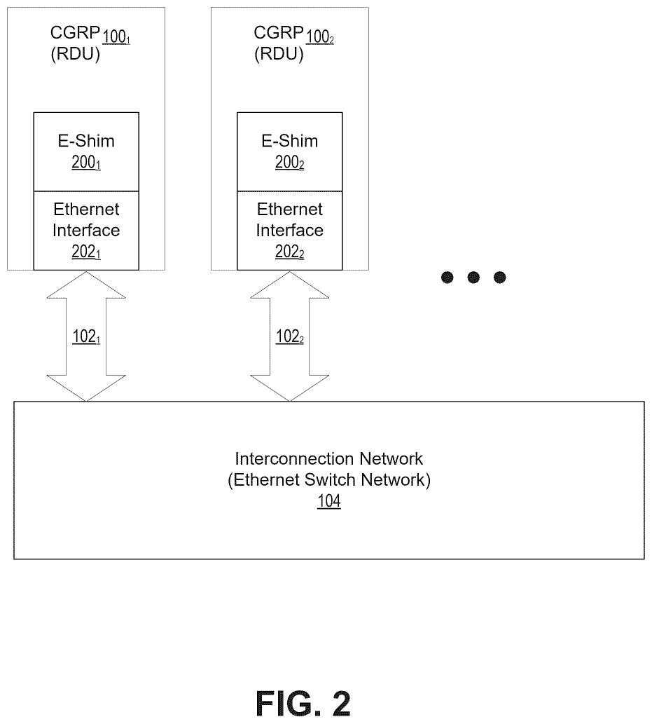

FIG. 2 shows further details of the interconnection network of the architecture of FIG. 1, according to embodiments of the present disclosure. The structure of FIG. 2 is shown to provide one embodiment wherein the interconnection network 104 is an Ethernet switch network. Although FIG. 2 shows the interconnection network 104 to be an Ethernet network, it is understood that other types of networks can be used according to embodiments of the present disclosure. With the Ethernet switch network, the CGRPs 100₁-100₂ include ethernet interfaces 202₁-202₂ that interface through connections 102₁-102₂ to the interconnection network 104.

As further shown, the CGRPs 100₁-100₂ can include Ethernet shim (E-shim) structures 200₁-200₂ that can be used to provide a simplified interconnection between the GDRPs 100₁-100₂ through the ethernet interfaces 202₁-202₂. To achieve a local to remote Ethernet direct access transaction between a source processor chip and a destination processor chip, the E-Shim connection in the source processor chip is used to initiate a data transfer from the source processor chip to the destination processor chip and encapsulate the source data into a payload of an Ethernet frame. The transfer of the Ethernet frame to the destination processor chip is then done where an E-Shim in the destination processor chip de-frames the received Ethernet frame to obtain the data transferred. This mechanism enables transactions between source and destination processor chips. Although the E-shim structures are shown, it is understood that embodiments can be provided with Ethernet interfaces 202₁-202₂ without use of the E-shim structures 200₁-200₂.

As further illustrated in FIG. 2, the CGRPs 100₁-100₂ can be reconfigurable data units (RDUs). Although the CGRPs are shown to be RDUs, the CGRA can likewise be another type of reconfigurable processor. With the CGRPs being RDUs the overall structure still includes the E-shim 200₁-200₂ and Ethernet interfaces interface circuits 202₁-202₂ to couple to the intra-RDU network through interconnect network 104. With an RDU, the interface circuit receives a packet from the external interconnect and extracts a target RDU identifier and compares the target RDU identifier to the value of the identity register. It also communicates over the intra-RDU network to a function interface based on information in the first packet in response to the target RDU identifier being equal to the identity register. The interface circuit retrieves another interface circuit identifier for the target RDU identifier from the pass-through table and, in response to the target RDU identifier not being equal to the identity register, sends the target RDU identifier and other information to the other interface circuit over the intra-RDU network.

The RDUs can be interconnected to provide a unique vertically integrated platform. Traditional multicore processors have limitations on performance gains that have tapered off. As a result, developers can no longer depend on traditional performance improvements to power more complex and sophisticated applications. This holds true for both CPU fat-core and GPU thin-core architectures. The RDU provides a new approach to extract more useful work from current semiconductor technologies. The RDU vertically integrated structure further provides for deep learning for artificial intelligence advancements.

The RDUs also satisfy a need for learning systems that unify machine-learning training and inference. Today, it is common for GPUs to be used for training and CPUs to be used for inference based on their different characteristics. GPUs and CPUs demonstrate continual and sometimes unpredictable change, which means predictive accuracy of models created by these systems declines without frequent updates. The RDU architecture efficiently supports both training and continuous learning with accuracy improvements while also simplifying the develop-train-deploy, machine-learning life cycle. The RDU approach is also flexible enough to support broader workloads and facilitate the convergence of machine learning and high performance computing (HPC).

Details of an Ethernet protocol that can be used in embodiments described herein allow for a lossless communication protocol that uses the concept of streams to communicate across chips for the purpose of scale-out. Scale-out refers to communication of data between the CGRP chips 100₁-100₂ in a manner to emulate a neural network to perform AI processing.

The Ethernet interface network connections 202₁-202₂ between chips can be over a Shim providing E-Shim connections 200₁-200₂ as described above, to make communication efficient. In embodiments described, each E-Shim stream can manage lossless connections between two E-Shims across two different RDU chips. An E-Shim stream is an aggregation and encapsulation of peer-to-peer (P2P) and Ethernet Direct Memory Access (EDMA) traffic from one RDU's I/O to another RDU's I/O. An E-Shim stream encapsulates several elements including: source RDU ID, source MAC address, destination RDU ID, destination MAC address, stream specific buffers and hardware elements.

In practice, E-Shim can support up to 16K streams. However, due to hardware limitations related to the configuration of embodiments described herein, an E-Shim can in some systems support only up to 256 concurrent network streams. Thus, every E-Shim stream, termed a new logic stream, being transmitted by E-Shim, is mapped to one of the 256 network streams.

Each of the 256 network streams can be in an active or inactive state. An active E-Shim transmitted network stream is actively transmitting packets. An inactive E-Shim network stream has sent out all packets of the logic stream assigned and transmitted to it and the receiver of the network stream has acknowledged receipt of all the packets.

Problems can arise when greater than 256 E-Shim network streams are used by a machine learning application and a new logic stream needs to be transmitted. The control logic hardware needs to evict an existing E-Shim network stream and replace it with a new E-Shim stream before a new logic stream can be transmitted using a network stream. Such a network stream replacement scheme when a network stream does become inactive needs to operate in an efficient manner.

Embodiments described herein provide for efficient operation of stream replacement by using certain features. As a first feature, all active network streams cannot be replaced until a network stream becomes inactive or otherwise packet transmission by the active stream would be interrupted. As a further feature, a network stream that has been inactive for the longest duration is chosen in a procedure described herein to replace an active stream. As a final feature, if there are no inactive network streams, then the transmitter should be stalled until a network stream becomes inactive.

Another problem can exist with evaluating 256 counters, one for each stream as this takes a lot of resources in hardware and cannot be done without levels of pipelining when operating at higher frequencies. The present disclosure, thus, introduces a pseudo-max counter identification algorithm that introduces a concept of buckets. To find the pseudo-max counter, the network streams are leveled or bucketized into separate prioritized buckets. For example, 10 buckets can be used with the 256 streams. Each bucket will have a 256 vector bit, one for each stream. A vector bit is set in a bucket when a stream goes inactive and the stream count value matches the count values allocated with the particular bucket. The 10 buckets significantly reduce the time to identify streams to make active as opposed to 256 different streams individually.

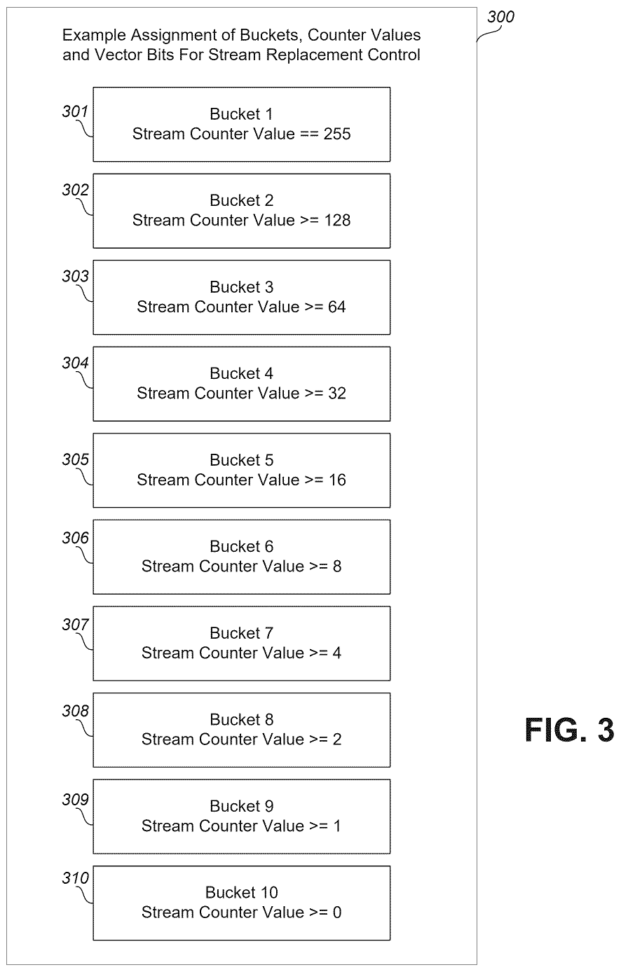

FIG. 3 is a block diagram illustrating features of an embodiment for the configuration of components 300 in control logic in the interconnection network 104 and CRPGs 100₁-100₆ of FIG. 1 to efficiently control stream replacement that illustrates the concept of buckets. The configuration assigns a counter for each stream. The streams are then assigned to buckets 301-310 based on their counter values. A stream from one of the buckets 301-310 is selected to replace a stream going inactive so that the stream that has been inactive the longest will be used first to replace a stream going inactive.

In operation, the counter associated with each stream is reset to zero when the stream transitions from an active to an inactive state. Then the counter is incremented when any other of the streams transition from an active to an inactive state so that the inactive streams with the highest count value have been inactive the longest. The streams are then assigned to the buckets 301-310 based on their counter values so that buckets with the lowest number have streams assigned with the highest count values. For example, referring to FIG. 3, bucket 1 has only streams assigned with a count value of 255. Bucket 2 has streams assigned with a count value greater than or equal to 128. Bucket 3 has streams assigned with a count value greater than or equal to 64, and so forth. When seeking an inactive stream to replace a stream going inactive, the control logic of the interconnection network 104 begins with the lowest numbered bucket and proceeds to higher numbered buckets until it finds a stream available within the bucket for activation. The use of buckets in this way provides a more efficient way to identify an available stream than to review the counter of each stream individually.

Each bucket 301-310 in FIG. 3 is assigned a vector with the total number of vector bits equal to the total number of streams used in the network. An example, in one embodiment the vector bits is 256 for identifying 256 chips. However, it can be desirable to have as many as 16K interconnected chips. Because of the limited number vector bits representing available streams for the 16K chips, a stream replacement algorithm is needed when only 256 streams are available for the 16K chips. Note that although 256 vector bits and available streams are given by way of example, it is within the knowledge of a person of ordinary skill that other numbers than then number 256 may be used for the total vector bits.

With use of the vector bits, after a stream becomes inactive and is available for activation, its vector bit is set in one or more buckets based on its count value being available within the bucket. For example, an inactive stream with vector bit 100 and a count value of 50 will have the vector bit 100 set in all of buckets 5-10. The vector bit is set in the appropriate buckets after a stream goes inactive when the stream is available to be made active. When an inactive stream is desired, the buckets are evaluated from lowest number to highest until a bucket is identified with one or more vector bits set indicating that a stream within the bucket is available for activation.

As illustrated in FIG. 3, in one embodiment a given stream can be mapped to multiple buckets when a counter value for the given stream falls within a range of count values assigned to the multiple buckets. For example, with the structure of FIG. 3, a stream with a counter value of 16 will map to all of buckets 5-10. In an alternative embodiment, the buckets can be assigned counter values for streams where there is no overlap.

Although FIG. 3 shows a specific of buckets 301-310, with specific ranges of counter values for each bucket, this is only an example intended for purposes of illustration. As a person skilled in the art would realize, the number of buckets and ranges of counter values assigned for each bucket can be set based on design needs. For example, to ensure faster operation, less buckets can be selected. As can be seen, as the number of buckets approaches the number of vector bits, operation will be slower. Further, although the number of vector bits are shown assigned as a specific value, the vector bits are dependent upon the number of available streams and are varied dependent upon the number of streams in a particular design.

The structure of FIG. 3 is used in the control logic of the interconnect network 104 that can be formed as hardware. Method steps used with the structure of FIG. 3 to replace streams described in subsequent figures can further be provided in hardware formed in the control logic in the interconnect network 104. Such hardware logic is provided for more efficient operation than use of a control processor with method steps that are executed by the processor as controlled by software stored in memory.

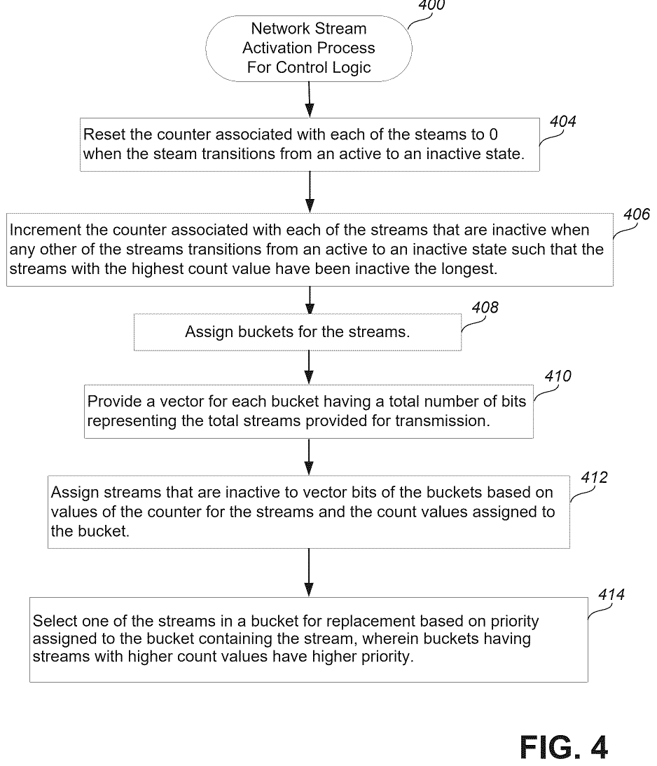

FIG. 4 is a flowchart showing method steps 400 for a stream replacement algorithm according to one embodiment of the present disclosure that can be implemented in the control logic of the network interconnection 104. The method of FIG. 4 uses a structure with buckets, vector bits and stream counter values as described with respect to FIG. 3. The method begins in step 404 where a counter associated with each of the steams is reset to 0 when the steam transitions from an active to an inactive state. In step 406 the counter associated with each of the streams that are inactive are incremented when any other of the streams transitions from an active to an inactive state such that the streams with the highest count value have been inactive the longest.

The steps of FIG. 4 continue with the allocation of buckets for the streams in step 408 and continues with selection of streams for activation using the buckets in subsequent steps. In step 410 a vector is provided for each bucket having a total number of bits representing the total streams provided for transmission. In step 412 streams that are inactive are assigned to the vector bits of the buckets based on values of the counter for the streams and the count values assigned to the bucket. Finally, in step 414 one of the streams in a bucket is selected for replacement based on priority assigned to the bucket, wherein buckets having streams with higher count values have higher priority.

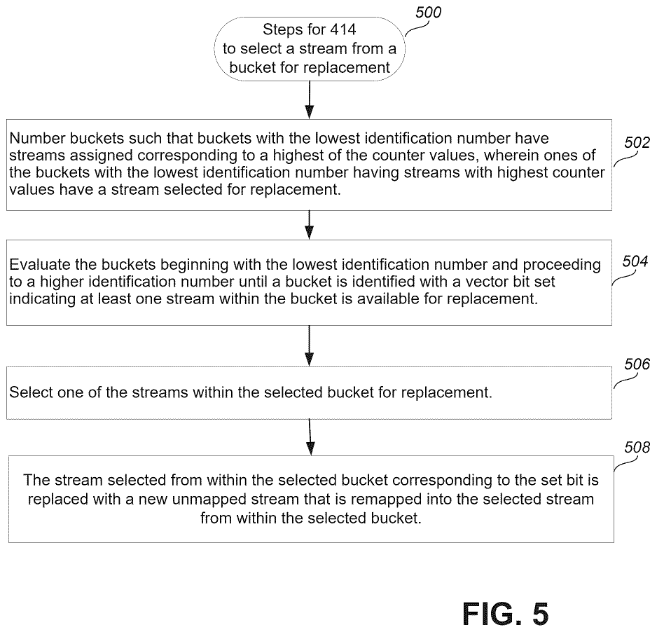

FIG. 5 is a flowchart showing further method steps 500 that provide details of operations for step 414 of FIG. 4 for selecting a stream from a bucket for replacement. First in step 502, the buckets are numbered such that buckets with the lowest identification number have streams assigned corresponding to a highest of the counter values, such that ones of the buckets with the lowest identification number having streams with highest counter values will have a stream selected for replacement. Next, in step 504 the buckets are evaluated beginning with the lowest identification number and proceeding to a higher identification number until a bucket is identified with a vector bit set indicating at least one inactive stream within the bucket is available for replacement with an active stream. In step 506 one of the streams is then selected from within the selected bucket to be replaced by an active stream. Finally in step 508 the selected stream from within the selected bucket corresponding to a set bit is replaced with a new unmapped active stream.

The process for step 508 of replacing a stream involves a core operation of mapping the stream selected from within a bucket once the stream is activated. As part of the process, the new unmapped stream is mapped into a stream selected from within a bucket that gets activated. Thus, the replacement stream from within the bucket is remapped and will replace the selected stream from within the bucket at which point the selected stream from withing the bucket will be activated. To ensure faster operation when selecting a stream from a bucket according to the stream replacement algorithm according to the steps of FIG. 5 when multiple vector bits are set within a bucket, one of the multiple set vector bits within the bucket can be randomly selected even if it is not identifying the stream with the highest counter value. Although evaluation of vector bits that are set within the bucket can be done to find the highest counter value, to increase operation speed a random selection of available streams within the bucket can be made in embodiments even though the stream with the highest counter is not used.

The bucket selection logic described with respect to FIG. 5 primarily comes into play when there are multiple inactive streams present that are identified in the buckets. If there are multiple inactive streams, then when a new unmapped stream arrives then only one stream from within a bucket will be selected to be replaced by the new stream. In many cases there will be only one inactive stream, in those cases this decision is trivial as the new stream will replace the only available inactive stream.

Some examples of how the bucket selection logic of FIG. 5 will work under different circumstances are described to follow. In these examples a frame of a new unmapped stream arrives, so an inactive stream must be replaced in order to map the new stream and transmit the frame. In a first example, there are many inactive streams available within the buckets. In this first example, the replacement algorithm of FIG. 5 will select one out of the inactive streams to be replaced. In a second example, there are no inactive streams, so the new unmapped steam will be stalled until a stream becomes inactive. In the second example, when one stream becomes inactive it will then immediately be selected for replacement which is a trivial decision for the replacement algorithm of FIG. 5. In a third example, similar to the second example, there are no inactive stream, so the new frame is again stalled until a stream becomes inactive. However, in this third example it is assumed that multiple steams become inactive approximately simultaneously. In this third example, the replacement algorithm of FIG. 5 will select one of these newly inactivated steams for replacement.

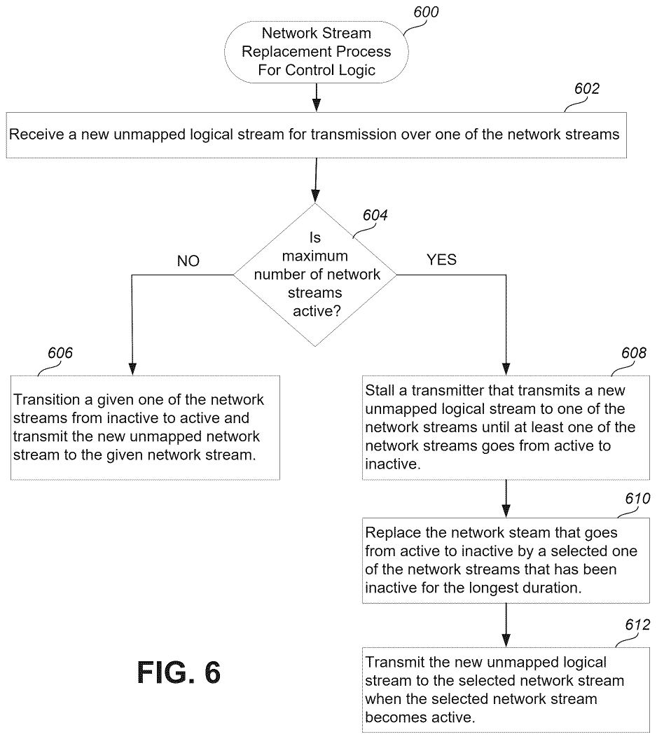

FIG. 6 is a flowchart beginning at 600 showing broadly method steps for a stream replacement algorithm from a time period of when a logic stream becomes available for transmission. FIG. 6 provides a broader view of the replacement algorithm of FIG. 4 and illustrates three primary goals in the stream replacement algorithm that may be implemented using the method steps of FIG. 4 or by alternative methods. The three primary guarantees provided by the steps shown in FIG. 6 are as follows: 1. Any active network stream is not replaced; 2. The network stream that has been inactive for the longest duration or as close as possible to the longest duration is the stream chosen to replace the latest network stream that transitions from active to inactive; and 3. When there are no inactive network streams and a logic stream becomes available for transmission, the transmitter for the logic stream becomes inactive until one of the network streams becomes inactive.

FIG. 6 begins in step 602 with receipt of a new unmapped logical stream for transmission over one of the network streams. Once a stream is received for transmission in step 602, the stream is made available for transmission. In one example of how transmission can work, suppose a component within RDU A wants to send a packet to RDU B. The compute component within RDU A will assign the packet to a stream that is destined to an eshim on RDU B and route the packet to an eshim on RDU A that has connectivity with an eshim on RDU B. Then on the eshim on RDU A the stream will be used to construct an ethernet packet that is sent to the eshim on RDU B.

Proceeding further in the process of FIG. 4 once a new unmapped logical stream is ready for transmission, in step 604 it is determined whether a maximum number of network streams are already active. If not, in step 606 there is no need to manage replacement of network streams until all of the streams have been assigned and replacement of an assigned stream with a new stream is necessary. So in step 606 a given one of the network streams is transitioned from inactive to active, without any management of stream replacement needed, and the new unmapped network stream is transmitted to the newly assigned active network stream. It is noted that the maximum number of streams is 100% of the network streams. So if a maximum number of network streams is active, or 100% are active, as determined in step 604, then in step 608 and subsequent steps, a replacement process is provided to assign the unmapped network stream for transmission over a network stream that is being deactivated.

Further in FIG. 6, when it is determined that the maximum number of streams has been reached and a stream is not available, the next step 608 begins with stalling a transmitter that transmits the new unmapped logical stream to one of the network streams until at least one of the network streams goes from active to inactive. The term “at least one of the network streams” is used because it is possible for multiple streams to transition to inactive simultaneously. Next in step 610, the network stream that goes from active to inactive is replaced by a selected one of the network streams that has been inactive for the longest duration. The method described with respect to FIG. 4 can be used to implement step 610. Finally in step 612 the new unmapped logical stream is transmitted to the selected network stream after the selected network stream becomes active.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

What is claimed is:

1. A method for prioritizing activation of network streams providing communications across chips, the method comprising:
associating a counter with each of the streams;
resetting the counter associated with each of the streams when the stream transitions from an active to an inactive state;
incrementing the counter associated with each of the streams that are inactive when any other of the streams transitions from an active to an inactive state such that one of the streams with the highest count value has been inactive the longest;
assigning a plurality of buckets for the streams;
providing a vector for each bucket having a total number of bits representing the total streams provided for transmission;
assigning ones of the streams that are inactive to vector bits of each one of the buckets based on values of the counter for the streams and the count values assigned to the bucket; and
selecting one of the streams for activation based on priority assigned to the bucket, wherein buckets having streams with higher count values have higher priority.

2. The method of claim 1, further comprising:
numbering buckets with a lowest identification number having streams assigned corresponding to a highest of the counter values,
wherein ones of the buckets with the lowest identification number having streams with highest counter values have a stream selected for activation first.

3. The method of claim 2, wherein selecting streams for activation further comprises:
evaluating the buckets beginning with the lowest identification number and proceeding to a higher identification number until a bucket is identified with a vector bit set indicating at least one stream within the bucket is available for activation;
selecting one of the streams for activation within the bucket identified with a stream available for activation; and
moving the selected stream corresponding to the set bit to an active state.

4. The method of claim 3, further comprising:
selecting another one of the streams to replace the selected stream for activation in the bucket after the selected stream is made active.

5. The method of claim 4, further comprising:
resetting the counter for the selected stream to 0 after the selected stream later completes transmission and becomes inactive.

6. The method of claim 3,
wherein there are 10 of the buckets;
wherein the total number of bits in the vector is 256;
wherein one of the vector bits in each of the buckets is set for an inactive one of the streams as follows:
bucket 1: counter value==255
bucket 2: counter value>=128
bucket 3: counter value>=64
bucket 4: counter value>=32
bucket 5: counter value>=16
bucket 6: counter value>=8
bucket 7: counter value>=4
bucket 8: counter value>=2
bucket 9: counter value>=1
bucket 10: counter value>=0

7. The method of claim 6,
wherein one of the streams can be mapped to multiple ones of the buckets;
wherein the bucket 1 has the highest priority for activation and the bucket 10 has the lowest priority for activation.

8. The method of claim 1,
wherein a given one of the streams can be mapped to multiple ones of the buckets when a counter value for the given stream falls within a range of the count values assigned to the multiple buckets.

9. The method of claim 3, wherein the vector bit for the stream selected for activation within the bucket identified with a stream available for activation is randomly selected.

10. The method of claim 3, wherein the vector bit for the streams selected for activation within the bucket identified with a stream available for activation has the highest count value.

11. The method of claim 1, wherein the streams are Ethernet streams.

12. A method for prioritizing activation of network streams providing communications across chips, the method comprising:
receiving a new unmapped logical stream for transmission over one of the network streams from one of the chips;
determining when a maximum number of the network streams are active,
wherein when not, transitioning a given one of the network streams from inactive to active and transmitting the new unmapped network stream to the given network stream, and
wherein when so, (i) stalling a transmitter that transmits a new unmapped logical stream to one of the network streams until one of the network streams goes from active to inactive, (ii) replacing the network stream that goes from active to inactive by a selected one of the network streams that has been inactive for the longest duration, and (iii) transmitting the new unmapped logical stream to the selected network stream when the selected network stream becomes active.

13. The method of claim 12, wherein the maximum number of the network streams are active when 100% of the network streams are active and no more of the network streams are available for making active.

14. The method of claim 12, wherein the step of replacing the network stream that goes from active to inactive comprises:
associating a counter with each of the network streams;
resetting the counter associated with each of the network streams when the network stream transitions from active to inactive;
incrementing the counter associated with each of the network streams that are inactive when any other of the network streams transitions from an active to inactive;
assigning a plurality of buckets for the network streams;
assigning the network streams to buckets based on values of the counter for the network streams; and
selecting the network streams for activation based on a priority assigned to the bucket.

15. The method of claim 14, wherein the step of replacing one of the network streams further comprises:
providing a vector for each bucket having a total number of bits representing the total streams provided for transmission;
assigning ones of the streams that are inactive to vector bits of each one of the buckets based on values of the counter for the streams and the count values assigned to the bucket; and
numbering buckets with a lowest identification number having streams assigned corresponding to a highest of the counter values, wherein ones of the buckets with the lowest identification number having streams with highest counter values have a stream selected for activation first.
evaluating the buckets beginning with the lowest identification number and proceeding to a higher identification number until a bucket is identified with a vector bit set indicating at least one stream within the bucket is available for activation;
selecting one of the streams for activation within the bucket identified with a stream available for activation; and
moving the selected stream corresponding to the set bit to an active state.

16. An apparatus for prioritizing activation of network streams for providing inter-chip communications comprising:
a plurality of chips;
network connections interconnecting the chips;
a dataflow traffic control logic for prioritizing the network streams for transmission over the network connections using the following steps:
receiving a new unmapped logical stream for transmission over one of the network streams from one of the chips;
determining when a maximum number of the network streams are active,
wherein when not, transitioning a given one of the network streams from inactive to active and transmitting the new unmapped network stream to the given network stream, and
wherein when so, (i) stalling a transmitter that transmits a new unmapped logical stream to one of the network streams until one of the network streams goes from active to inactive, (ii) replacing the network stream that goes from active to inactive by a selected one of the network streams that has been inactive for the longest duration, and (iii) transmitting the new unmapped logical stream to the selected network stream when the selected network stream becomes active.

17. The apparatus of claim 16, wherein the network connections comprise Ethernet connections.

18. The apparatus of claim 17, wherein the Ethernet connections comprise shim connections.

19. The apparatus of claim 16, wherein the chips comprise reconfigurable processors.

20. The apparatus of claim 16, wherein the chips comprise reconfigurable dataflow units (RDUs) providing a tiled architecture that provides for both hardware and software stacks for AI.
